(19) United States
(12) Patent Application Publication
(10) Pub. No.: US 2016/0333751 A1
(43) Pub. Date: Nov. 17, 2016

(54) Engine Insert and Process for Installing

(71) Applicant: Frank J. Ardezzone, Santa Clara, CA (US)

(72) Inventor: Frank J. Ardezzone, Santa Clara, CA (US)

(21) Appl. No.: 15/150,390

(22) Filed: May 9, 2016

Related U.S. Application Data
(60) Provisional application No. 62/158,487, filed on May 7, 2015.

(51) Int. Cl. F01L 3/22; B23P 15/00

(52) U.S. Cl. CPC F01L 3/22; B23P 15/001

(57) ABSTRACT

an engine insert having an insert appendage that projects outwardly from the insert body in a direction away from the seat face, into an engine, such as to form an engine finger void between the appendage and the insert axis, in which engine finger void a finger of engine material may be positioned between the insert appendage and the insert axis.

### CROSS-REFERENCE TO RELATED APPLICATIONS

This application claims the benefit of U.S. Provisional Application Ser. No. 62/158,487, filed on May 7, 2015, by the present inventors, entitled “Engine Insert and Process for Installing,” which is hereby incorporated by reference in its entirety for all allowable purposes, including the incorporation and preservation of any and all rights to patentable subject matter of the inventor, such as features, elements, processes and process steps, and improvements that may supplement or relate to the subject matter described herein.

### STATEMENT REGARDING FEDERALLY SPONSORED RESEARCH OR DEVELOPMENT

Not Applicable

### BACKGROUND OF THE INVENTION

This invention relates generally to internal combustion engine inserts, and more specifically, to a valve seat and installation process that establishes secure seat installation in an engine where the engine and seat are comprised of materials with dissimilar coefficients of expansion.

The field of manufacturing internal combustion engines has slowly developed over the past two centuries. Today, various materials are used in the engines and the engine components in an attempt to reduce weight, dissipate heat, and increase durability and reliability. For a long time the sealing surface of the intake and exhaust valves have employed special materials for the valves and perimeter of the manifold opening, known as a seat, to ensure proper selective fluid flow and sealing. With varied materials come varied physical properties, some which are desired, such as durability and heat dissipation, and some that are not desirable, such as differing thermal expansion. In particular, different coefficients of thermal expansion of the engine material of the part of the engine where the seat is placed and the seat material has been a problem to the field for a long time.

When the engine in which the seat is seated and the seat have differing coefficients of expansion, when the engine gets hot it expands at a different rate than the seat. Additionally, when the engine and seat get extremely cold, and then are started, the parts heat at different rates. In either scenario seats may become loose and interfere with the function of the valve and pistons, causing severe damage. Even recently, a major engine builder noted difficulty with “seats loosening up and dropping out in some of its late model 4.7 liter and 5.7 liter . . . engines” in an article in “Engine Builder Magazine,” entitled “Valve Seat Selection, Finishing & Materials.” This is in spite of the industry accepted best practice of heating the engine to over 200 degrees in a furnace, while chilling the seats with dry ice or liquid nitrogen, in order to press-fit the temporarily shrunk seat into the temporarily enlarged bore in the engine. Even with this augmented interference fit, experts in the field are still experiencing difficulties.

It would be an improvement to the field of art to have the valve seat and engine design where the interference fit between the engine and the seat does not greatly diminish with extreme temperatures and the rapid change in temperatures.

### SUMMARY OF THE INVENTION

The present development is a valve seat having an appendage that projects outwardly from the seat body in a direction away from the seat face, into an engine, such as to form an engine finger void between the appendage and the seat axis for a finger of engine material to be positioned between the valve seat appendage and the valve channel. The present design and process will result in increased retention impingement between the valve seat appendage and the finger of engine material, which offsets other diminished impingement areas between the appendaged valve seat and the engine. This applies to various engine and seat combinations of dissimilar materials over a large temperature range. The appendaged valve seat permits a process of securely press-fitting of the seat into the engine at ambient temperatures.

### BRIEF DESCRIPTION OF THE DRAWINGS

FIG. 1 is a perspective view of an exemplary appendaged seat according to the present invention;

FIG. 2 is a seat face side view of the seat in FIG. 1;

FIG. 3 is a side view normal to the cut side of the valve in FIG. 2, cut at line A-A;

FIG. 4a is a schematic cross-sectional side view illustration of a modified valve seat well in an engine according to the present invention;

FIG. 4b is a schematic cross-sectional side view of an alternate valve seat well according to the present invention;

FIG. 4c is a schematic cross-sectional side view of an alternate valve seat well according to the present invention;

FIG. 4d is a schematic cross-sectional side view of an alternate valve seat well according to the present invention;

FIG. 5a is a schematic side view illustration of a cutaway embodiment of the current appendaged valve seat similar to that shown in FIG. 3 seated in the modified valve seat well shown in FIG. 4a;

FIG. 5b is an enlarged view of the valve appendage illustrated in FIG. 5a;

FIG. 6 is a schematic side view of a cutaway alternate embodiment seated in the modified valve seat well shown in FIG. 4b;

FIG. 7 is a schematic side view of an additional cutaway alternate embodiment seated in the modified valve seat well shown in FIG. 4c;

FIG. 8 is a schematic side view of a further additional cutaway alternate embodiment seated in the modified valve seat well shown in FIG. 4d;

FIG. 9 is a flowchart illustrating an exemplary process for installing an appendaged valve seat in an engine; and

FIG. 10 is a flowchart illustrating an exemplary process for making an appendaged valve seat.

### DESCRIPTION OF THE PREFERRED EMBODIMENT

It is understood that valves, and their corresponding intake and exhaust ports, may be positioned in various locations in the engine, and may have varied orientations. The current disclosure will discuss a configuration where the valves and valve channels are located in the engine head, and the valves are generally shown to be positioned above the bulk of the combustion chamber. However, the current device and process may be used in engines where the valves and valve channels are otherwise located, such as being positioned in the engine block or being below the combustion chambers.

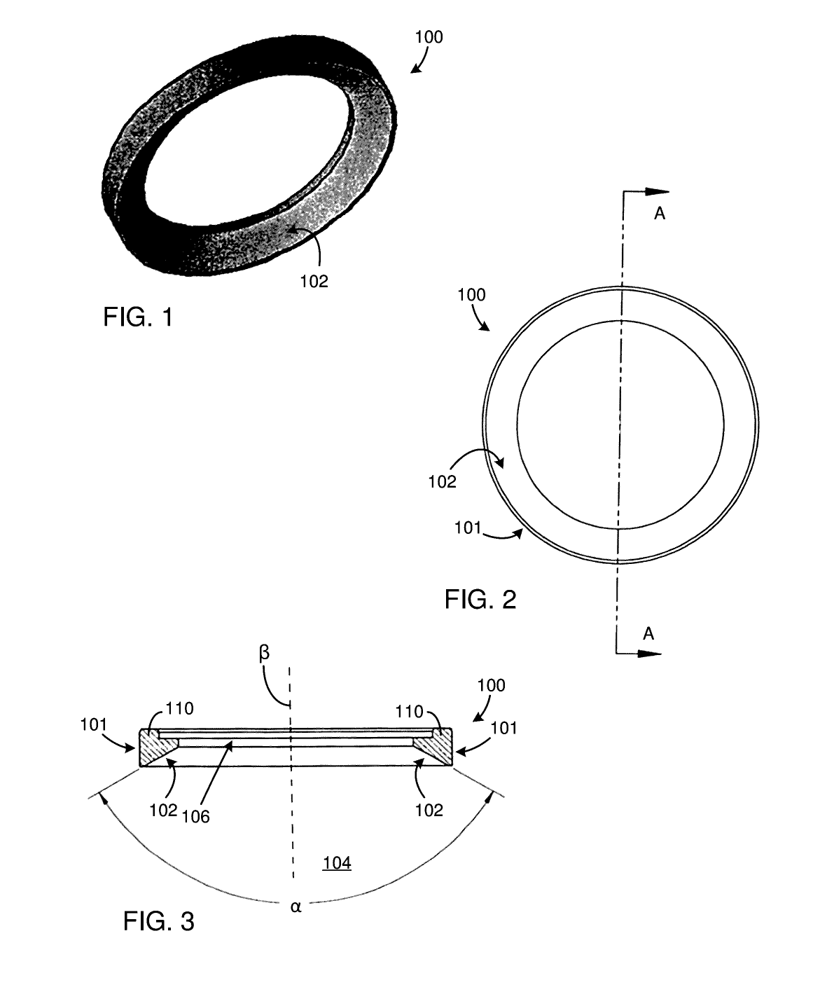

An exemplary embodiment of the current appendaged seat 100 is shown in FIGS. 1-3. The valve seat 100 has a ringed shape with a seat perimeter 101. Many aspects of valve seat 100 are similar to prior art valve seats, with a seat face 102 facing a combustion chamber 104. The center of the valve seat 100 is a circular void that forms part of the valve channel 106 through which fuel-air mixture may enter and exhaust may exit the combustion chamber 104. The seat face 102 is the element against which a valve (not shown) is intended to rest to prevent fluid flow through the valve channel 106. The seat face 102 typically fans-out at an angle α, which corresponds to a flared angle of the corresponding sealing surface of the appropriate valve (not shown). The flare may be a flat angled section or a precise arc that contacts the valve face and provides good sealing and heat transfer when the valve is closed, and good gas-flow characteristics through the valve port when it is open. The ringed shape of the valve seat 100 creates a reference axis β around which the cylindrical features of valve seat 100 may be seen as encircling.

An additional feature shown in FIG. 3 is a seat appendage 110. The seat appendage 110, which may extend from the body of the valve seat 100 distal the seat face 102.

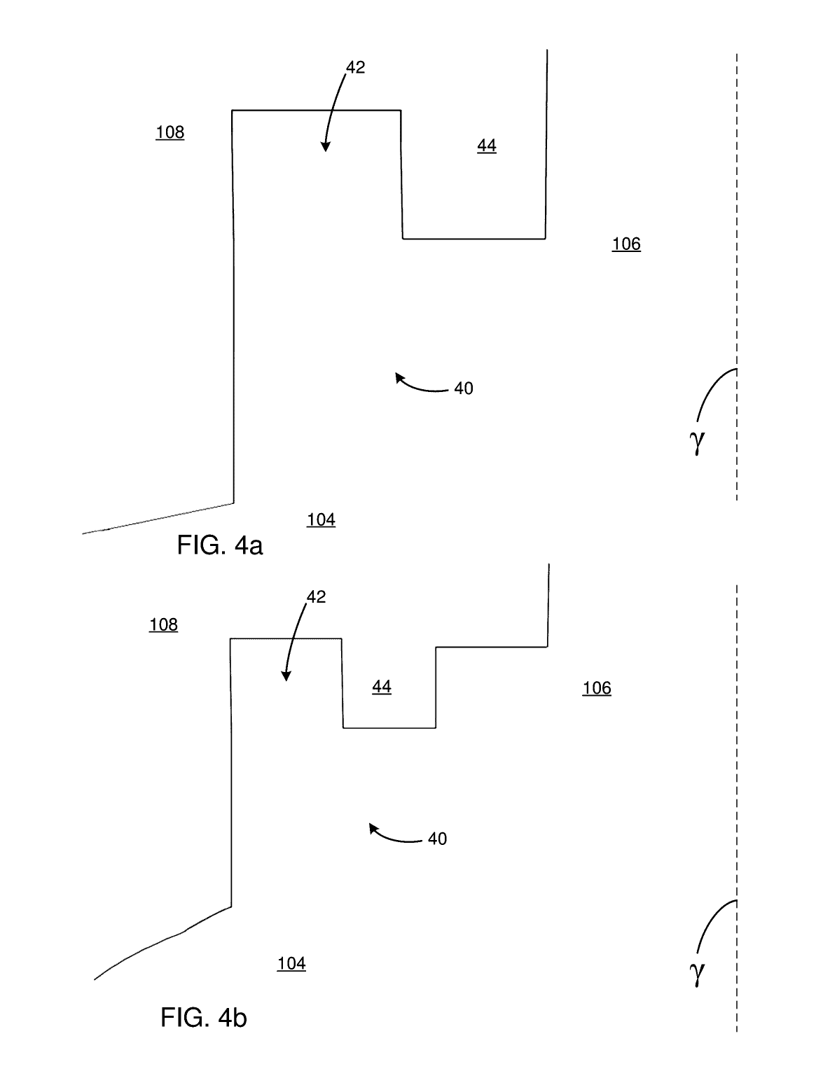

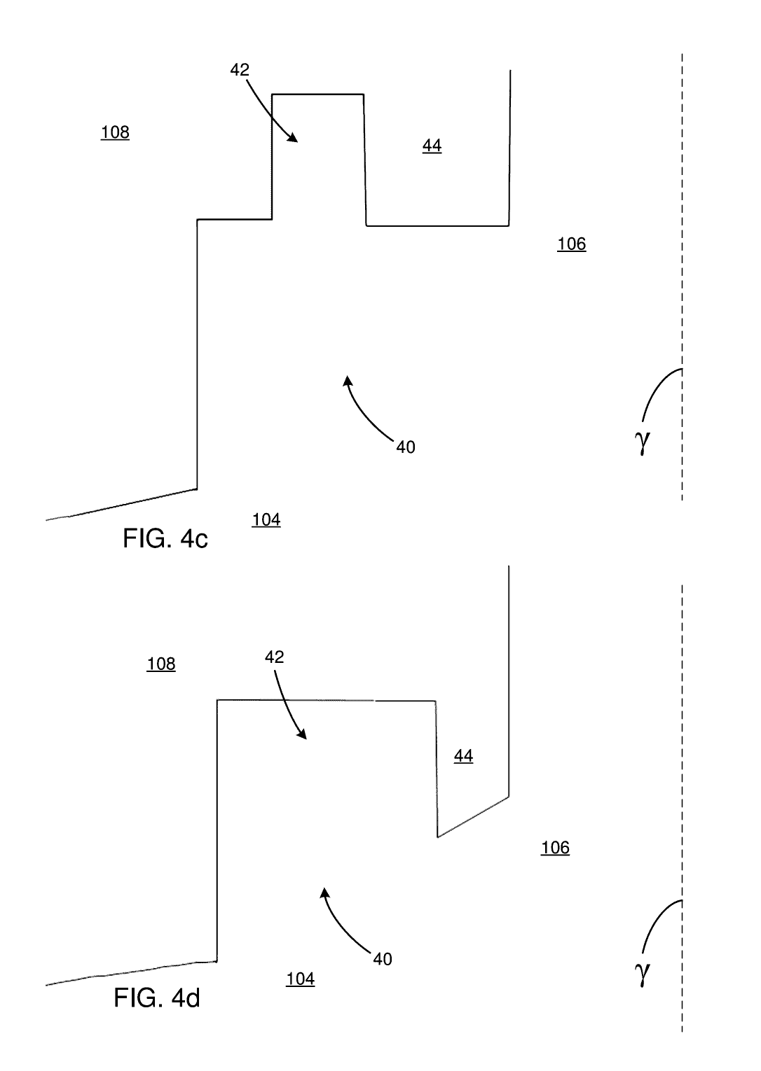

Referring now primarily to FIGS. 4a, 4b, 4c, and 4d, a variety of modified valve seat wells 40 useable in a variety of engines are shown. It is appreciated that other configurations of seat wells 40 may be applicable to the present teachings. In the exemplary embodiments, the seat wells 40 are located in the engine head 108, which is a typical configuration, but there are situations where the seat wells 40 may be in a different part of the engine, such as the engine block. It is appreciated that the exemplary seat wells 40 may be round, and centered on a well axis γ. The seat wells 40 are located at the interface between the engine head 108 and the combustion chamber 104, where the valve channel 106 accesses the combustion chamber 104.

To accommodate the seat 100 with a seat appendage 110, an exemplary seat well 40 may have a counter-bored groove 42 that may extend a portion of the seat well 40 further into the engine head 108 in a direction parallel to well axis γ. In the exemplary embodiment, the counter-bored groove 42 creates an engine finger 44 of engine material of head 108 remaining between the counter-bored groove 42 and the valve channel 106. In the exemplary embodiment, the finger 44 of engine material completely circles the valve channel 106, centered on well axis γ.

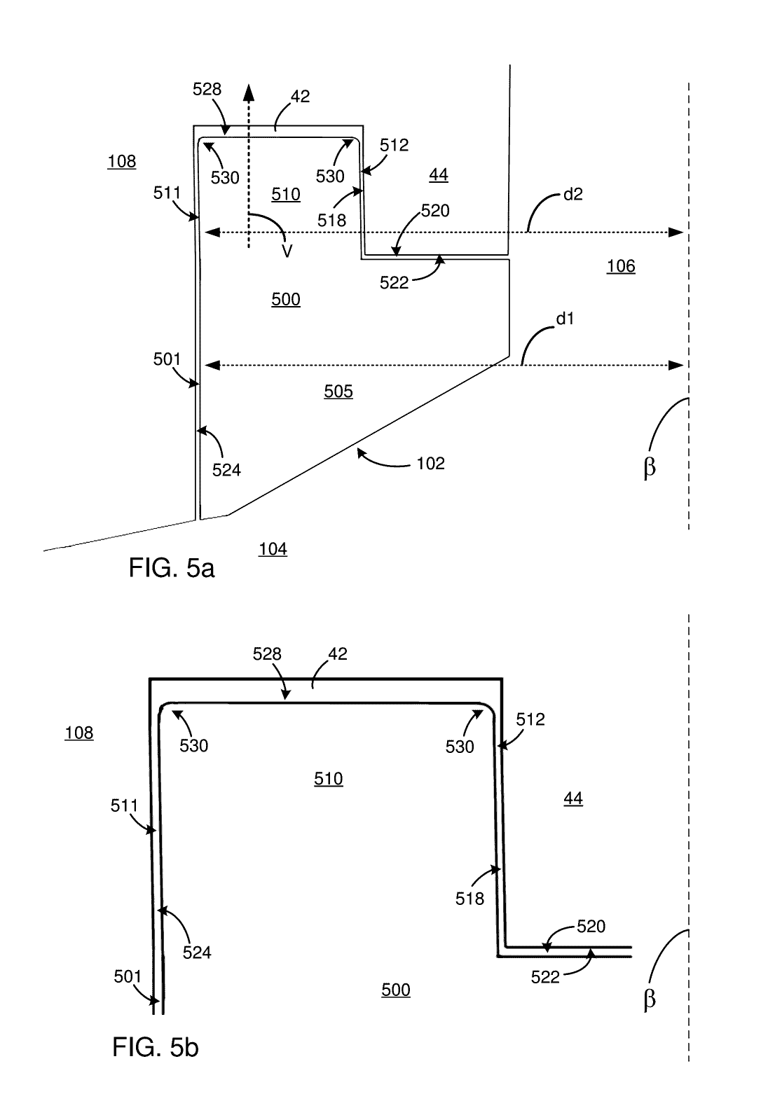

Referring now primarily to FIGS. 5a and 5b, an exemplary appendage valve seat 500, similar in structure to the appendage valve seat 100 in FIG. 3, is schematically shown from a cut-through side to show orientation and features with respect to the engine head 108. The interface gaps shown are not to scale, but are enlarged for illustration purposes. As in appendaged valve seat 100, appendaged valve seat 500 may have a seat perimeter 501 may be seen to form the exterior circumferential, cylindrical surface of valve seat 500 centered on axis β. The distance between the seat perimeter 501 and the seat axis β is illustrated by line d1. Appendaged valve seat 500 may have a valve seat body 505 and an appendage 510. Vector V illustrates that seat appendage 510 may extend outwardly, in the direction of vector V from the seat body 505 parallel to the seat axis β.

In the exemplary embodiment, appendage 510 may have an appendage perimeter 511 that aligns with the seat perimeter 501 parallel to axis β and distal axis β. In its entirety, exemplary, exemplary appendage perimeter 511 may be seen to form a circumferential, cylindrical exterior surface of exemplary appendage 510 centered on axis β. The distance between the appendage perimeter 511 and the seat axis β is illustrated by line d2. An exemplary appendage face 512 may be parallel to appendage perimeter 511, and on the opposite side of appendage 510. In its entirety, exemplary appendage face 512 may be seen to form a circumferential, cylindrical interior surface of exemplary appendage 510 parallel to appendage perimeter 511, and similarly centered on seat axis β.

In an installed configuration, seat axis β and well axis γ may be co-located, and appendage 510 of seat 500 may extend into a counter-bored groove 42 in engine head 108. An exemplary engine finger 44 may be seen as formed between the valve channel 106 and the counter-bored groove 42. An engine finger face 518 may be formed to be parallel to appendage face 512, appendage perimeter 511 and seat perimeter 501 when valve seat 500 is properly seated in engine head 108 in the installed configuration. Exemplary valve seat 500 may have a reference stop 520 perpendicular to seat perimeter 501 and a point on axis β. Reference stop 520 may abut engine finger face 522 when valve seat 500 is properly seated in engine head 108 in the installed configuration. A tight abutment between reference stop 520 and engine finger face 522 may prohibit combustion residue from valve channel 106 entering into the interface and creating unwanted debris accumulation.

When valve seat 500 is properly seated in engine head 108 in the installed configuration seat perimeter 501 may abut firmly against seat bore outer face 524. To obtain secure press-fit interference between the valve seat 500 and the engine head 108 seat perimeter 501 and appendage face 512 may be precisely, correspondingly sized to abut firmly against seat bore outer face 524 and engine finger face 518. In this disclosure, press-fit interference is the amount that the distance between exemplary seat perimeter 501 and appendage perimeter 511, and exemplary appendage face 512 is greater than the width of the exemplary counter-bored groove 42. A press-fit interference of between 0.0001 and 0.002 is suggested, but the precise interference fit may vary dependent upon materials and component sizes, as do conventional interference specs. However, the current invention permits reliable seating with less interference fit, so it may be press-fit to an installed configuration under ambient temperatures.

Exemplary appendage 510 may have an exemplary appendage leading face 528, which faces the bottom of exemplary counter-bored groove 42. Exemplary edges 530 may be seen as formed at both the interface of exemplary appendage perimeter 511 and exemplary appendage leading face 528, and exemplary appendage face 512 and exemplary appendage leading face 528. Edges 530 may be the edge of exemplary appendage 510 distal seat face 102.

Exemplary edges 530 may be slightly rounded sufficiently to permit the smooth insertion of appendage 510 into the counter-bored groove 42. Edges 530 may be rounded in order to enable the press-fitting of exemplary appendage 510 into counter-bored groove 42 when appendage 510 is sized slightly larger than counter-bored groove 42, as may be desirable to obtain a secure press-fit interference between the exemplary valve seat 500 and the engine head 108 in an installed configuration. A rounded edge may permit the narrower appendage leading edge 528 at the start of the curve radii of the rounded edges 530 to fit in between the seat bore outer face 524 and the engine finger face 518. The rounded edges 530 may then push the edge material of the seat bore outer face 524 and the engine finger face 518 outwardly during press-fitting. A sharp leading edge to the appendage 510 might likely shave material off the opening edge of the seat bore outer face 524 and the engine finger face 518, potentially creating unwanted debris in the counter-bored groove 42.

In the exemplary embodiment, the counter-bored groove 42 may be cut with the groove for the appendage 510 being slightly deeper than required to abut reference shoulder 520 and engine finger face 522 in an installed configuration, creating a space between the bottom wall of the counter-bored groove 42 and the appendage leading edge 528. Unwanted debris may be pushed into this space so it may not interfere with the proper function of the engine and its components.

In an exemplary embodiment, the present design may result in increased retention impingement between the valve seat appendage 510 and the finger of engine material 44, which may offset the other diminished impingement areas between the seat perimeter 501 of the appendaged valve seat 500 and the seat bore outer face 524 of the engine 108. This effect may be experienced in an over-heating situation or in a situation where the engine system is in extreme cold when it is started. With an increase or decrease in temperature, both the engine 108 and the seat 500 expand or contract according to the material's coefficient of thermal expansion.

It is understood that when an engine is heated the bores within the engine expand radially. Insert components, such as valve seats typically also expand, however, they expand to a different amount or degree. The amount or degree of expansion may depend on several factors and physical properties of the material. In a general heating example, the engine may be primarily made of aluminum, which expands substantially, and the valve seats may be made of a steel alloy, which may expand to a substantially lesser degree. A conventional press-fit installation, assisted with heat-treatment of the engine and cold-treatment of the valve seat, may still reach a point during extreme operation where the expanded conventional engine seat well will be large enough to no longer hold the slightly expanded seat.

The present development overcomes the differences, regardless of the coefficient of thermal expansion differences, by having multiple parallel interface surfaces where the position of the material with regard to the central axis β, around which the predominant expansion occurs, is alternated. Still referring to FIGS. 5a and 5b, when the engine 108 and the seat 500 are made of materials with different coefficients of thermal expansion, the degree either part changes in size varies. When heated there is an increased distance between axis β and any point in engine 108 and engine finger 44, and at the same time a different increase in distance between axis β and any point in seat 500, including appendage 510. The present disclosed design has at least two sets of parallel interface surfaces between the engine material (108, 44), and the seat 500 and appendage 510. One set of these interface surfaces is the engine 108 and the appendage perimeter 511, and the other set is the appendage face 512 and the engine finger 44. Since in the first instance the seat 500 is closer to the axis β than the engine 108, and the second instance the engine 108 is closer to the axis β than the seat 500, when the force between the surfaces in one interface decreases, the force between the surfaces in the other parallel interface increases. Though there may be slight differences in the amount of the increase and decrease between the two interfaces, the effect is sufficient to provide a substantial improvement in reliability that the appendage seat 500 will stay in place in engine 108.

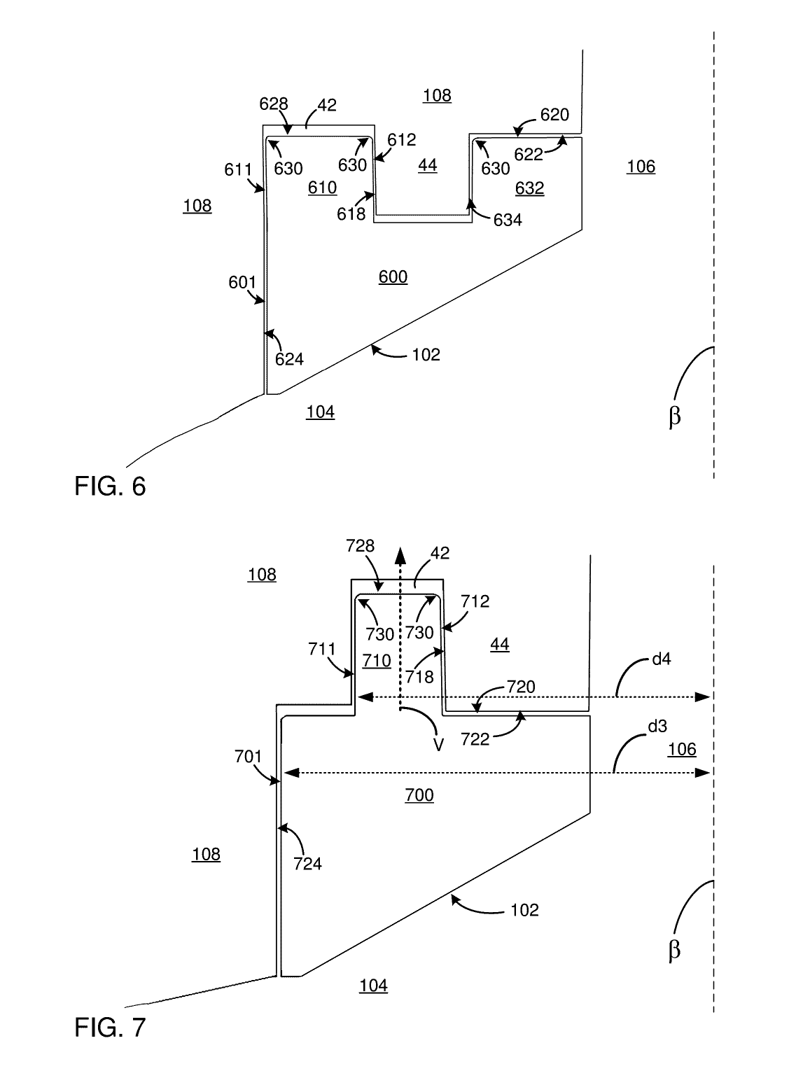

Referring now primarily to FIG. 6, an alternate exemplary appendage valve seat 600 is schematically shown from a cut-through side, as done in FIG. 4, to show orientation and features with respect to an engine head 108 in a simplified manner. The interface gaps shown are not to scale, but are enlarged for illustration purposes. Axis β is depicted to provide a reference to its general location from the valve seat 600, but the distance axis β is from the valve seat 600 is not to scale.

As in appendaged valve seat 100, appendaged valve seat 600 has an exemplary seat perimeter 601 that forms the exterior circumferential, cylindrical surface of the valve seat 600 centered on axis β. In the exemplary embodiment, appendage 610 has an appendage perimeter 611 that is aligned with the seat perimeter 601 parallel to axis β and distal axis β. In its entirety, exemplary appendage perimeter 611 forms a circumferential, cylindrical exterior surface of exemplary appendage 610 centered on axis β. Parallel to the appendage perimeter 611 and on the opposite side of the appendage 610 from the appendage perimeter 611 is an appendage face 612. In its entirety, exemplary appendage face 612 forms a circumferential, cylindrical, inwardly facing surface of appendage 610 centered on axis β.

Exemplary appendage 610 extends into a counter-bored groove 42 in engine head 108. An exemplary engine finger 44 is formed between the valve channel 106 and the counter-bored groove 42. An engine finger face 618 is formed that is parallel to appendage face 612, appendage perimeter 611 and seat perimeter 601 when exemplary alternate valve seat 600 is properly seated in engine head 108. Exemplary valve seat 600 has a reference stop 620, which may be perpendicular to seat perimeter 601 and a point on axis β. Reference stop 620 is intended to abut engine finger stop 622 when valve seat 600 is properly seated in engine head 108.

When valve seat 600 is properly seated in engine head 108 seat perimeter 601 abuts firmly against seat bore outer face 624. To obtain secure press-fit interference between the alternate valve seat 600 and the engine head 108 seat perimeter 601 must be precisely, correspondingly sized to abut firmly against seat bore outer face 624. In this disclosure press-fit interference is the amount that the distance between seat perimeter 601 and appendage face 612 is greater than the width of the counter-bored groove 42. As with exemplary embodiment valve seat 500, press-fit interference of between 0.0005 and 0.002 is suggested for exemplary valve seat 600.

Exemplary appendage 610 has an appendage leading face 628, which faces the bottom of counter-bored groove 42. Edges 630 are formed at both the interface of appendage perimeter 611 and appendage leading face 628, and appendage face 612 and appendage leading face 628. Exemplary edges 630 are at the edge of appendage 610 distal seat face 102. Exemplary edges 630 may be slightly rounded sufficiently to permit the smooth insertion of appendage 610 into the counter-bored groove 42. Edges 630 may be rounded in order to enable the press-fitting of appendage 610 into counter-bored groove 42 when appendage 610 is sized slightly larger than counter-bored groove 42, as is desirable to obtain a secure press-fit interference between the valve seat 600 and the engine head 108.

Exemplary alternate valve seat 600 may have one or more additional appendages 632. Additional appendages 632 may have similar features as appendage 610 to facilitate proper press-fit installation. Additional appendages 632 may have a finger interface 634 parallel to the interface formed by appendage face 612 and engine finger face 618.

Referring now primarily to FIG. 7, an additional alternate exemplary appendage valve seat 700 is schematically shown from a cut-through side, as done in FIG. 4, to show orientation and features with respect to an engine head 108 in a simplified manner. The interface gaps shown are not to scale, but are enlarged for illustration purposes. Axisβ is depicted to provide a reference to its general location from the valve seat 700, but the distance axis β is from the valve seat 700 is not to scale. The distance between the seat perimeter 701 and the seat axis β is illustrated by line d3.

As in appendaged valve seat 100, appendaged valve seat 700 has an exemplary seat perimeter 701 that forms the exterior circumferential, cylindrical surface of the valve seat 700 centered on axis β. In the exemplary embodiment, appendage 710 has an appendage perimeter 711 that is parallel to the seat perimeter 701. The distance between the appendage perimeter 711 and the seat axis β is illustrated by line d4. Parallel to the appendage perimeter 711 and on the opposite side of the appendage 710 from appendage perimeter 711, closer to axis β, is an appendage face 712. In its entirety, exemplary appendage face 712 forms a circumferential, cylindrical interior surface of exemplary appendage 710 centered on axis β.

Exemplary appendage 710 extends into a counter-bored groove 42 in engine head 108. An exemplary engine finger 44 is formed between the valve channel 106 and the counter-bored groove 42. An engine finger face 718 is formed that is parallel to appendage face 712, appendage perimeter 711 and seat perimeter 701 when exemplary alternate valve seat 700 is properly seated in engine head 108. Exemplary valve seat 700 has at least one reference stop 720, which may be perpendicular to seat perimeter 701 and a point on axis β. Reference stop 720 is intended to abut at least one engine finger stop 722 when valve seat 700 is properly seated in engine head 108.

When valve seat 700 is properly seated in engine head 108 seat perimeter 701 abuts firmly against exemplary seat bore outer face 724. To obtain secure press-fit interference between the alternate valve seat 700 and the engine head 108 seat perimeter 701 must be precisely, correspondingly sized to abut firmly against seat bore outer face 724. In this disclosure press-fit interference is the amount that the distance between seat perimeter 701 and appendage face 712 is greater than the width of the counter-bored groove 42. As with exemplary embodiment valve seat 600, press-fit interference of between 0.0005 and 0.002 is suggested for exemplary valve seat 700.

Exemplary appendage 710 has an appendage leading face 728, which faces the bottom of counter-bored groove 42. Edges 730 are formed at both the interface of appendage perimeter 711 and appendage leading face 728, and appendage face 712 and appendage leading face 728. Exemplary edges 730 are at the edge of appendage 710 distal seat face 102. Exemplary edges 730 may be slightly rounded sufficiently to permit the smooth insertion of appendage 710 into the counter-bored groove 42. Edges 730 may be rounded in order to enable the press-fitting at ambient temperatures of appendage 710 into counter-bored groove 42 when appendage 710 is sized slightly larger than counter-bored groove 42, as is desirable to obtain a secure press-fit interference between the valve seat 700 and the engine head 108.

Exemplary alternate valve seat 700 may have one or more additional appendages 732 coaxial to axis β. Additional appendages 732 may have similar features as appendage 710 to facilitate proper press-fit installation. Additional appendages 732 may have a finger interface 734 parallel to the interface formed by appendage face 712 and engine finger face 718, and centered on axis β.

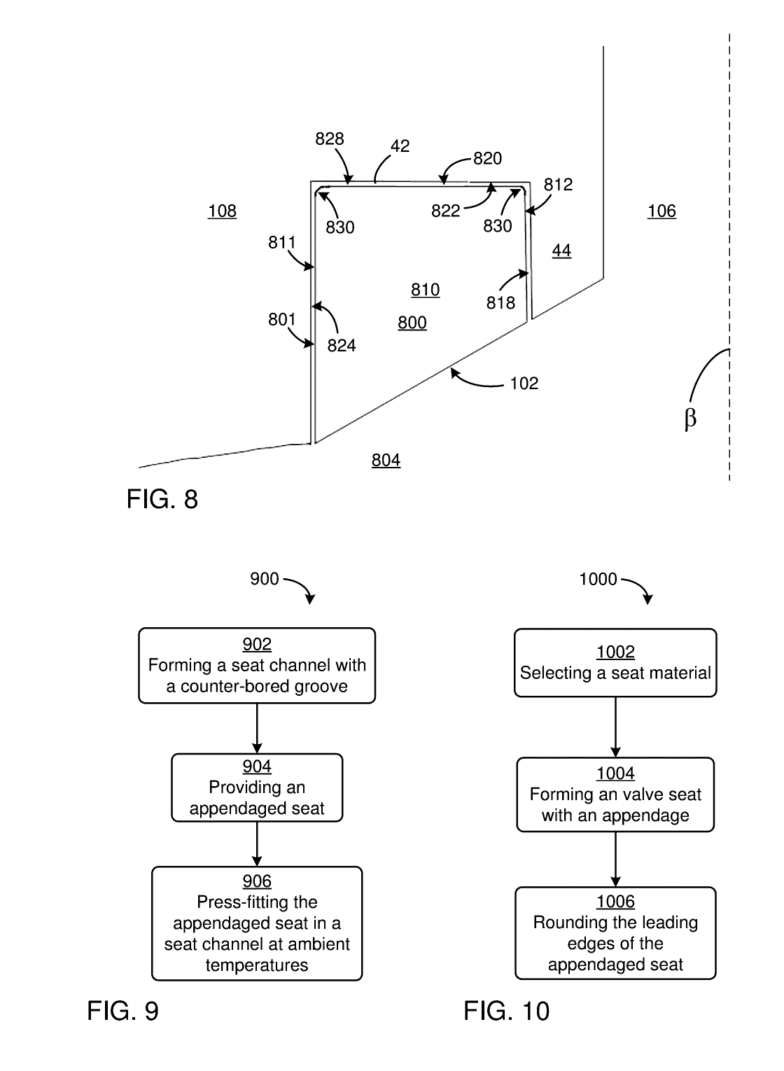

Referring now primarily to FIG. 8, a further additional alternate exemplary appendage valve seat 800 is schematically shown from a cut-through side, as done in FIG. 4, to show orientation and features with respect to an engine head 108 in a simplified manner. The interface gaps shown are not to scale, but are enlarged for illustration purposes. Axis (3 is depicted to provide a reference to its general location from the valve seat 800, but the distance axis β is from the valve seat 800 is not to scale.

As in appendaged valve seat 100, appendaged valve seat 800 has an exemplary seat perimeter 801 distal axis β that forms the exterior circumferential, cylindrical surface of the valve seat 800 centered on axis β. In the exemplary embodiment of appendaged valve seat 800, appendage 810 is embodied in the upper portion of appendaged valve seat 800 distal seat face 102. In the exemplary embodiment, appendage 810 has an appendage perimeter 811 that is parallel to the seat perimeter 801. Parallel to the appendage perimeter 811 and on the opposite side of the appendage 810 from appendage perimeter 811 is an appendage face 812. In its entirety, exemplary appendage face 812 forms a circumferential, cylindrical interior surface of exemplary appendage 810 centered on axis β.

Exemplary appendage 810 extends into a counter-bored groove 42 in engine head 108. An exemplary engine finger 44 is formed between the valve channel 106 and the counter-bored groove 42. An engine finger face 818 is formed that is parallel to appendage face 812, appendage perimeter 811, seat perimeter 801 and axis β, when exemplary alternate valve seat 800 is properly seated in engine head 108. Exemplary valve seat 800 has a reference stop 820, which may be perpendicular to seat perimeter 801 and a point on axis β. Reference stop 820 is intended to abut the engine finger stop 822 formed by the bottom of the counter-bored groove 42 when valve seat 800 is properly seated in engine head 108.

When valve seat 800 is properly seated in engine head 108 seat perimeter 801 abuts firmly against exemplary seat bore outer face 824. To obtain secure press-fit interference between the alternate valve seat 800 and the engine head 108 seat perimeter 801 must be precisely, correspondingly sized to abut firmly against seat bore outer face 824. In this disclosure press-fit interference is the amount that the distance between seat perimeter 801 and appendage face 812 is greater than the width of the counter-bored groove 42. As with prior exemplary embodiment valve seat 600, press-fit interference of between 0.0005 and 0.002 is suggested for exemplary valve seat 800.

Exemplary appendage 810 has an appendage leading face 828, which faces the bottom of counter-bored groove 42. Edges 830 are formed at both the interface of appendage perimeter 811 and appendage leading face 828, and appendage face 812 and appendage leading face 828. Exemplary edges 830 are at the edge of appendage 810, distal seat face 102.

Exemplary edges 830 may be slightly rounded sufficiently to permit the smooth insertion of appendage 810 into the counter-bored groove 42, even at ambient temperatures. Edges 830 may be rounded in order to enable the press-fitting of appendage 810 into counter-bored groove 42 when appendage 810 is sized slightly larger than counter-bored groove 42, as is desirable to obtain a secure press-fit interference between the valve seat 800 and the engine head 108. This is especially true when the various parts are not respectively heat-expanded or cold-shrunk before installation. The angling of edges 830 permits appendage leading face 828 to be positioned into the counter-bored groove 42 before the valve seat 800 makes contact with the outer edges of the counter-bored groove 42. The rounded edges 830 will then press the outer edges of the counter-bored groove 42 outwardly, rather than binding with the outer edges of the counter-bored groove 42 and potentially shaving off material, which would become unwanted debris in the counter-bored groove 42. It is appreciated that edges 830 may be angled or tapered in various manners to achieve the angled transition into the counter-bored groove 42.

Exemplary alternate valve seat 800 may have one or more additional appendages 832 coaxial to axis β. Additional appendages 832 may have similar features as appendage 810 to facilitate proper press-fit installation. Additional appendages 832 may have a finger interface 834 parallel to the interface formed by appendage face 812 and engine finger face 818, and centered on axis β.

Referring now primarily to FIG. 9, the process of securely press-fitting of the seat into the engine head at ambient temperatures 900 is shown. Given the advantageous function of the appendaged valve seat 100 (and including 500, 600, 700, and 800), the typical manufacturing steps of heating an engine head 108 and cooling a conventional seat may be avoided. The appendaged valve seat 100 may be secured in engine head 108 by forming 902 a seat well 40 with a counter-bored groove 42 extending into the engine head 108 distal the seat face 102, and an engine finger 44 intermediate the counter-bored groove 42 and the valve channel 106.

The exemplary process may also include providing 904 an appendaged seat 500 where the seat body 505 has a seat axis β, a seat face 102 shaped to seal against a valve, and a seat perimeter 501 oriented away from the seat axis β, the appendaged seat 500 may have a seat appendage 510, the seat appendage 510 may have an appendage perimeter 511 oriented away from the seat axis β and an appendage face 512 oriented toward the seat axis β, and the seat perimeter 501, the appendage perimeter 511, and the appendage face 512 coaxial to the seat axis β.

Additionally, the exemplary process may include press-fitting 906 an appendaged valve seat 100 in a seat channel 40 at ambient temperatures with an interference fit may be accomplished by seating methods known in the field to squarely seat a valve seat in an engine head 108.

Referring now primarily to FIG. 10, the general process of making an appendaged seat 1000 is shown. The process includes selecting 1002 a desired seat material that has the desired properties for the engine. The exemplary process also includes forming 1004 a valve seat 40 with an appendage 42, using the chosen seat material, such that the seat body 505 may have a seat axis β, a seat face shaped to seal against a valve, and a seat perimeter 501 oriented away from the seat axis β, the valve seat 500 may have a seat appendage 510, the seat appendage 510 may have an appendage perimeter 511 oriented away from the seat axis β and an appendage face 512 oriented toward the seat axis β, and the seat perimeter 501, the appendage perimeter 511, and the appendage face 512 may be coaxial to the seat axis β. Additionally, rounding 1006 the leading edges 530 of the appendaged seat 500, so that the leading edges do not shave off part of the entry perimeter of the seat well 40 and create unwanted debris in the seat well 40. This rounding of the leading edges makes the seat more suitable for press-fit installation in ambient temperatures.

Example inventive scope of the currently disclosed device and process may include a valve seat 500 for an engine, having an engine head material with a different coefficient of expansion than the valve seat material, comprising a seat body 505 with a cylindrical seat perimeter 501, a seat face 102, a seat axis β, and a radial reference stop 520, the valve seat 500 having a seat appendage 510, the seat appendage 510 having a cylindrical appendage perimeter 511 and a cylindrical appendage face 512, the seat perimeter 511, the appendage face 512, and the appendage perimeter 511 coaxial to the seat axis β, the cylindrical appendage face being closer to the seat axis β than the appendage perimeter 511. Additionally, the valve seat 500 may further comprise the seat 511 extending outwardly from the seat body 505 distal the seat face 102. Further, the valve seat 500 may further comprise the appendage perimeter 511 and appendage face 512 each having a leading edge 530, and at least one of one leading edge 530 being rounded or tapered.

From another viewpoint, exemplary inventive scope may include an engine insert for an engine, the engine having an insert seat well 40, and an engine material with a different coefficient of expansion than the engine insert material, comprising, an engine insert body with an insert perimeter, an insert axis, and a radial reference stop, the engine insert body having an insert appendage, the insert appendage having an appendage perimeter and an appendage face, the insert perimeter, the appendage perimeter, and the appendage face coaxial to the insert axis, and the insert appendage extending outwardly from the insert body distal the seat face. Additionally, an exemplary embodiment may include the insert appendage extending outwardly from the insert body in a direction parallel to the insert axis, such as to form an engine finger void between the insert appendage and the insert axis in which engine finger void a finger of engine material may be positioned between the insert appendage and the insert axis. Additionally, an exemplary embodiment may include the appendage perimeter and appendage face each having a leading edge, and at least one of one leading edge being rounded. Additionally, an exemplary embodiment may include the insert perimeter and the appendage perimeter being equidistance from the insert axis. Additionally, an exemplary embodiment may include the distance from the insert perimeter to the insert axis being greater than the distance from the appendage perimeter to the insert axis.

The examples contained in this specification are merely possible implementations of the current device and process, and alternatives to the device and to the particular steps, including the scope and sequence, may still fall within the scope of the allowed claims. The foregoing disclosure and description of the invention is illustrative and explanatory thereof. The examples contained in this specification are merely possible implementations of the current device and process, and alternatives to the particular features, elements and process steps, including scope and sequence of the steps may be changed without departing from the spirit of the invention. The present invention should only be limited by the following claims and their legal equivalents, since the provided exemplary embodiments are only examples of how the invention may be employed, and are not exhaustive.

I claim:

1. A valve seat, comprised of a material, for an engine having a valve seat well, a valve channel, and an engine material with a different coefficient of expansion than the valve seat material, comprising:
a seat body with a seat axis, a seat face shaped to seal against a valve, and a seat perimeter oriented away from the seat axis;
the seat body having a seat appendage;
the seat appendage having an appendage perimeter oriented away from the seat axis and an appendage face oriented toward the seat axis; and
the seat perimeter, the appendage perimeter, and the appendage face coaxial to the seat axis.

2. The valve seat of claim 1, further comprising:
the seat appendage extending outwardly from the seat body parallel to the seat axis.

3. The valve seat of claim 1, further comprising:
the seat appendage extending outwardly from the seat body distal the seat face;
an engine finger void between the seat appendage and the seat axis sized to receive a finger of engine material from between the valve seat well and the valve channel.

4. The valve seat of claim 1, further comprising:
the appendage perimeter and appendage face each having a leading edge, and at least one leading edge being rounded.

5. The valve seat of claim 1, further comprising:
the seat perimeter and the appendage perimeter being equidistance from the seat axis.

6. The valve seat of claim 1, further comprising:
a distance from the seat perimeter to the seat axis being greater than a distance from the appendage perimeter to the seat axis.

7. A process for securing a valve seat in an engine, comprising:
forming a seat channel with a counter-bored groove in the engine to accommodate a seat body with a seat axis, a seat face shaped to seal against a valve, and a seat perimeter oriented away from the seat axis, the seat body having a seat appendage, the seat appendage having an appendage perimeter oriented away from the seat axis and an appendage face oriented toward the seat axis, and the seat perimeter, the appendage perimeter, and the appendage face coaxial to the seat axis; and
press-fitting an appendage seat in the seat channel while the engine and appendage seat are at an ambient temperature.

8. The process of claim 7, further comprising:
rounding at least one leading edge of the appendage perimeter and appendage face.

9. The process of claim 7, further comprising:
forming the appendage perimeter and the seat perimeter to be equidistance form the seat axis.

10. The process of claim 7, further comprising:
forming the appendage perimeter to be closer to the seat axis than the seat perimeter.

11. A process for creating a valve seat for an engine having an engine material with a different coefficient of expansion than the valve seat material, comprising:
selecting a desired seat material; and
forming a seat body with a seat axis, a seat face shaped to seal against a valve, and a seat perimeter oriented away from the seat axis, the seat body having a seat appendage, the seat appendage having an appendage perimeter oriented away from the seat axis and an appendage face oriented toward the seat axis, and the seat perimeter, the appendage perimeter, and the appendage face coaxial to the seat axis.

12. The process of claim 11, further comprising:
rounding at least one leading edge of the appendage perimeter and appendage face.

13. An engine insert for an engine, the engine having an insert well, and an engine material with a different coefficient of expansion than the engine insert material, comprising:
an engine insert body with an insert axis and an insert perimeter oriented away from the insert axis;
the engine insert body having an insert appendage;
the insert appendage having an appendage perimeter oriented away from the insert axis and an appendage face oriented toward the insert axis; and
the insert perimeter, the appendage perimeter, and the appendage face coaxial to the insert axis.

14. The engine insert of claim 13, further comprising:
the insert appendage extending from the insert body.

15. The engine insert of claim 13, further comprising:
the insert appendage extending in a direction parallel to the insert axis, such as to form an engine finger void between the insert appendage and the insert axis, in which engine finger void a finger of engine material may be positioned between the insert appendage and the insert axis.

16. The engine insert of claim 13, further comprising:
the appendage perimeter and appendage face each having a leading edge, and at least one of one leading edge being rounded.

17. The engine insert of claim 13, further comprising:
the insert perimeter and the appendage perimeter being equidistance from the insert axis.

18. The engine insert of claim 13, further comprising:
the distance from the insert perimeter to the insert axis being greater than the distance from the appendage perimeter to the insert axis.
